(19) United States
(12) Patent Application Publication
(10) Pub. No.: US 2016/0039145 A1
(43) Pub. Date: Feb. 11, 2016

(54) THREE-DIMENSIONAL PRINTING APPARATUS

(71) Applicant: Timothy Wayne Steiner, Pittsboro, NC (US)

(72) Inventor: Timothy Wayne Steiner, Pittsboro, NC (US)

(21) Appl. No.: 14/820,112

(22) Filed: Aug. 6, 2015

Related U.S. Application Data
(60) Provisional application No. 62/035,013, filed on Aug. 8, 2014.

(51) Int. Cl. B29C 67/00

(52) U.S. Cl. CPC B29C 67/0085; B29C 67/0055; B29K 2105/16

(57) ABSTRACT

A three-dimensional printing apparatus configured to print a three-dimensional object is provided. The three-dimensional printing apparatus may include a print head that extrudes or deposits an electrically non-conductive material and an electrically conductive material. Said electrically conductive material may be configured to substantially form continuous electrically conductive paths and an electrically non-conductive material may be configured to substantially insulate said electrically conductive material. In one example, the three-dimensional printing apparatus may be employed to print a three-dimensional object that may be used to form an electrical circuit. In another example, the three-dimensional printing apparatus may be employed to print a three-dimensional object that may comprise features that may reduce electromagnetic interference (“EMI”).

### CROSS-REFERENCE TO RELATED APPLICATIONS

The present Utility patent application claims priority benefit of the [U.S. provisional application for patent Ser. No. 62/035,013 entitled “Three-dimensional printer for printing a conductive material and a non-conductive material” filed 2014 Aug. 8 under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to three-dimensional printers. More particularly, the invention relates to a three-dimensional printer for printing conductive and non-conductive materials.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. It is believed that three-dimensional printers are well-known devices that are typically employed to lay down successive layers of non-conductive material, usually comprised of a plastic or polymer structure, under computer control to form a three dimensional object. However, three-dimensional printers may also be employed for other purposes. For example, without limitation, three-dimensional printers may be employed to print a conductive material within a non-conductive material. The conductive material may include, without limitation, conductive ink, conductive plastic, or conductive polymer structure that may include conductive particles such as, but not limited to, powdered or flaked silver particles therein. In some applications the conductive material within the non-conductive material may be used to form circuits or perform related functions.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a front perspective view of an exemplary three-dimensional printer head configured to print an exemplary three-dimensional object comprising conductive material surrounded by non-conductive material, in accordance with an embodiment of the present invention;

FIG. 2 is a cross-sectional view of an exemplary three-dimensional object, in accordance with an embodiment of the present invention; and

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” limits the scope of a claim to the specified elements or method steps, plus those that do not materially affect the basis and novel characteristic(s) of the claimed subject matter.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of.”

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

An embodiment of the present invention may comprise a three-dimensional printer, which may be employed to print a three-dimensional object that may be used to form an electrical circuit. Some embodiments may comprise a structure and method for producing a three-dimensional object that may be produced by layering non-conductive material with conductive material. In these embodiments the three-dimensional object may typically be produced by extruding or depositing material through one or more three-dimensional printer heads.

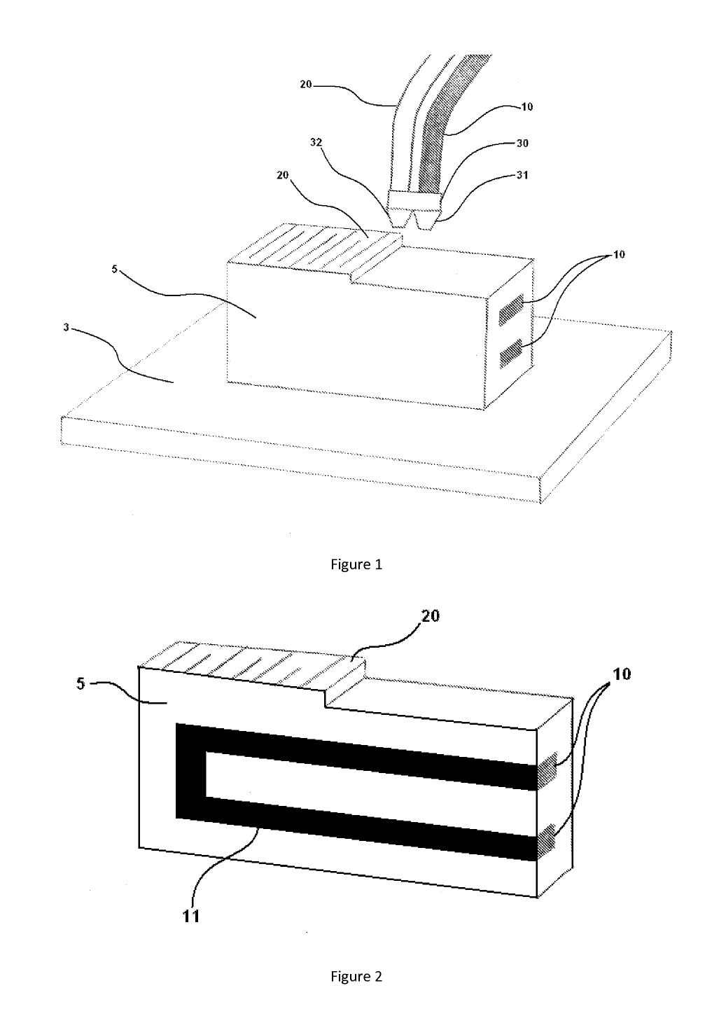

FIG. 1 is a front perspective view of an exemplary three-dimensional object 5 positioned on top of a print bed 3, in accordance with an embodiment of the present invention. In the present embodiment, the three-dimensional object 5 is positioned such that a print head 30 is configured to print a non-conductive material 20 through a non-conductive material nozzle 32 and a conductive material 10 through a conductive material nozzle 31.

In the present embodiment The non-conductive material 20 is layered with the conductive material 10 to form the three-dimensional object 5. Those skilled in the art will readily recognize, in light of and in accordance with the teachings of the present invention, that three-dimensional objects may be produced in many shapes and arrangements including, but not limited to sphere, hemisphere, cylinder, cone, cube, cuboid, torus, prism, pyramid, etc.

FIG. 2 is a cross-sectional view of the exemplary three-dimensional object of FIG. 1 cut in half showing electrically conductive path 11 formed of a conductive material 10, in accordance with an embodiment of the present invention. In the present embodiment, the three-dimensional object 5 comprises at least one layer of conductive material 10 and at least one layer of non-conductive material 20. Conductive material 10 is typically an electrically conductive material that may be configured to overlap to form continuous electrically conductive paths. Conductive material 10 may be produced in any shape, arrangement, or appropriate pattern forming a continuous conductor, such as, but not limited to, serpentine patterns, rectilinear patterns, zigzag patterns, spiral patterns, etc. In some embodiments the conductive material may form multiple conductive paths that may connect to the same or separate electrical connectors and electrical devices. In the present embodiment, conductive material 10 may be comprised of a multiplicity of suitable materials including, without limitation, conductive ink, conductive plastic, conductive polymer material, various other non-ink, non-plastic and non-polymer materials, materials comprising conductive particles, metal, thermoplastic polyurethane, carbon nanotubes, carbon black etc. In the present embodiment, non-conductive material 20 typically comprises material that is not electrically conductive and may act as insulation around the electrically conductive paths of conductive material 10. Non-conductive material 20 may be comprised of a plastic or polymer material, however various different non-plastic and non-polymer materials may be utilized for the non-conductive material in some embodiments such as, but not limited to, rubber, polyurethane, etc. Non-conductive material 20 layer may be produced in any appropriate pattern to insulate conductive material 10. Non-conductive material may also form the shape of the object. In some alternate embodiments the non-conductive material may be used to insulate the conductive material, and a different material may be used to form the shape of the object. In the present embodiment, conductive material 10 and non-conductive material 20 may be formed by being extruded or deposited in successive layers by means of three-dimensional printing, which may be easier, less time consuming, and less expensive than other production means. However, it is contemplated that some embodiments may be produced using a multiplicity of suitable alternative means such as, but not limited to, injection molding, plastic extrusion, pressing methods, etc.

It is contemplated that some embodiments may comprise features that may reduce electromagnetic interference (“EMI”). For example, without limitation, in some embodiments the conductive material may shield electrical components from ingress and egress electromagnetic induction or ingress and egress electromagnetic radiation. This may reduce or prevent electromagnetic interference from occurring.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a three-dimensional printer for printing electrically conductive paths according to the present invention will be apparent to those skilled in the art. Various aspects of the invention have been described above by way of illustration, and the specific embodiments disclosed are not intended to limit the invention to the particular forms disclosed. The particular implementation of the a three-dimensional printer for printing electrically conductive paths may vary depending upon the particular context or application. By way of example, and not limitation, the three-dimensional printer for printing electrically conductive paths described in the foregoing were principally directed to implementations for producing three-dimensional printed electrical circuits; however, similar techniques may instead be applied to print different items such as, but not limited to, antennas or electromagnetic interference shields, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A three-dimensional printing apparatus, comprising;
a print head comprising;
a nozzle configured to extrude or deposit an electrically non-conductive material to form an electrically non-conductive layer of a three-dimensional object;
a nozzle configured to extrude or deposit an electrically conductive material to form an electrically conductive layer of a three-dimensional object;
whereby said electrical non-conductive material forms a layer configured to substantially insulate said electrically conductive material layer;
whereby said electrically conductive material layer and electrically non-conductive material layer are extruded or deposited in successive layers; and
a print bed;

2. The three-dimensional printing apparatus of claim 1, wherein said print head is configured to switch between non-conductive and conductive material.

3. The three-dimensional printing apparatus of claim 1, wherein said print head is movable over at least a portion of said print bed.

4. The three-dimensional printing apparatus of claim 1, wherein said print bed provides a surface for support of said three-dimensional object.

5. The three-dimensional printing apparatus of claim 1, wherein said print bed is heated.

6. The three-dimensional printing apparatus of claim 1, wherein said electrically conductive material forms electrically conductive paths.

7. The three-dimensional printing apparatus of claim 1, wherein said electrically conductive material is comprised of conductive ink.

8. The three-dimensional printing apparatus of claim 1, wherein said electrically conductive material is comprised of conductive plastic.

9. The three-dimensional printing apparatus of claim 1, wherein said electrically conductive material is comprised of conductive polymer.

10. The three-dimensional printing apparatus of claim 1, wherein said electrically conductive material contains conductive particles.

11. The three-dimensional printing apparatus of claim 1, wherein said electrically conductive material is comprised of metal.

12. The three-dimensional printing apparatus of claim 1, wherein said three-dimensional object is fabricated from a representation of the object stored in memory.

13. A method of fabricating a three-dimensional object, comprising;
positioning a print head proximate a print bed;
extruding or depositing an electrically non-conductive material onto the print bed;
adjusting a position of the print head proximate to the print bed;
extruding or depositing an electrically conductive material onto the print bed;

14. The method of claim 13, wherein said electrically non-conductive material is heated.

15. The method of claim 13, wherein said electrically conductive material is heated.

16. The method of claim 13, wherein said electrically conductive material and said electrically non-conductive material are extruded or deposited in successive layers.
